(19) United States
(12) Patent Application Publication
(10) Pub. No.: US 2003/0044571 A1
(43) Pub. Date: Mar. 6, 2003

(54) Ballistic vest

(76) Inventor: Floribertus Cornelis Hermanus Mokveld, Roermond (NL)

Correspondence Address: PILLSBURY WINTHROP, LLP, P.O. BOX 10500, MCLEAN, VA, 22102, US

(21) Appl. No.: 10/221,018

(22) PCT Filed: Mar. 9, 2001
(86) PCT No.: PCT/NL01/00200

(30) Foreign Application Priority Data
Mar. 10, 2000 (NL) 1014609

(51) Int. Cl. B32B 5/12

(52) U.S. Cl. 428/105; 428/113

(57) ABSTRACT

The invention relates to a ballistic vest comprising a stack of flexible unidirectional layers in which the unidirectional layers contain polyphenylene benzobisoxazole (PBO) fibers and in which the fibers in a unidirectional layer run substantially parallel and are positioned at an angle of more that 0 degrees relative to fibers in an adjacent layer, wherein the PBO fibers are as-spun PBO fibers which preferably have a modulus of less than 1300 cN/dTex.

The invention relates to a ballistic vest comprising a stack of flexible unidirectional layers in which the unidirectional layers contain poly(p-phenylene-2,6,-benzobisoxazole) (PBO) fibres and in which the fibres in the unidirectional layers run substantially parallel and are positioned at an angle of more that 0 degrees relative to fibres in an adjacent layer.

Such a vest is known from WO-A-9749546.

WO-A-9749546 describes clothing which possesses antiballistic properties and contains a stack of flexible unidirectional layers in which the unidirectional layers contain aramid or PBO fibres and in which the fibres in a unidirectional layer run substantially parallel and are positioned at an angle of 90 degrees relative to fibres in an adjacent layer.

In order to obtain the highest possible protective effect from ballistic vests, materials are used which offer the highest possible energy absorption per surface unit for one or more types of bullets.

The aim of the invention is to provide a vest which offers the highest possible energy absorption per surface unit.

This aim is achieved due to the fibres being as-spun PBO fibres. As a result of this, the energy absorption per unit of surface for different types of bullets is about 15% higher than in the case of a PBO fibre which has been subjected to a post-spinning treatment to give the fibre a higher modulus.

The modulus of an as-spun fibre and the aftertreated fibre (HM) for a PBO fibre from Toyobo (Zylon®) are given in Table 1.

TABLE 1

| Type | Tensile modulus (cN/dTex) |
|---|---|
| Zylon AS | 1060 |
| Zylon HM | 1678 |

Surprisingly it has been found that a vest made from PBO fibres having a modulus of less than 1300 cN/dTex shows better ballistic properties than a vest made from PBO fibres having a modulus higher than 1300 cN/dTex. This is in contrast to the generally known teaching that a fibre having a higher modulus has better ballistic properties than a fibre having a lower modulus.

The stack of UD layers can consist of one or more UD packs. The stack of UD layers preferably consists of several UD packs, each of which contains two or four UD layers. The packs are preferably provided with a smooth film on either side, reducing the friction between the packs and enhancing the flexibility of the stack.

By ‘fibres’ in this context are understood objects having a length that is much larger than its width and thickness. Fibres comprise continuous mono- and multifilaments as well as discontinuous filaments such as staple fibres or cut fibres.

The invention will now be elucidated by means of a few examples.

By the ‘areal density’ of a fabric or UD layer or pack is understood the fabric or UD layer weight per surface unit.

The PBO fibre used in the experiments was a Zylon fibre from Toyobo, having a titre of 1100 dTex. Using this material, Zylon UD packs were made with a matrix on the basis of a styrene-isoprene-styrene block copolymer dispersion in water.

Zylon UD is a pack of two layers laid crosswise in which the fibres in each layer run virtually parallel and are positioned normal to the fibres in an adjacent layer. The yam weight per layer amounts to 36 g/m². The Zylon UD pack comprises a rubber matrix and is on both sides covered with a polyethylene film of 7 g/m². A Zylon UD pack has an areal density of 100 g/m². The matrix content amounts to 17 wt. % relative to the total of matrix and fibre weight.

### EXAMPLE 1

V50 measurements were carried out on vests of stacks of a varying number of Zylon (AS) UD packs. On the basis of the V50 and the areal density of the vest the energy absorption per surface unit of the vest was determined (Eabs). The results are presented in Table 2.

TABLE 2

| | Areal density | | |
|---|---|---|---|
| Threat | (kg/m2) | V50 (m/s) | Eabs (J/(kg/m2) |
| 9 mm | 2 | 405 | 335 |
| | 2.6 | 463 | 333 |
| | 3.3 | 482 | 285 |
| .357 JSP | 2.6 | 466 | 418 |
| .44 Magnum | 3.7 | 461 | 445 |
| FSP 17 | 2.6 | 457 | 44 |
| Grain | | | |

### Comparative Experiment A

V50 measurements were carried out on vests of stacks of a varying number of Zylon (HM) UD packs. On the basis of the V50 and the areal density of the vest the energy absorption per surface unit of the vest was determined (Eabs). The results are presented in Table 3.

TABLE 3

| | Areal density | | |
|---|---|---|---|
| Threat | (kg/m2) | V50 (m/s) | Eabs (J/(kg/m2) |
| 9 mm | 1.8 | 432 | 424 |
| | 2.3 | 455 | 366 |
| FSP 17 grain | 2.6 | 467 | 47 |
| .44 Magnum | 3.7 | 489 | 506 |
| .357 JSP | 2.6 | 490 | 472 |

From these results it appears that the energy absorption of vests containing PBO (AS) fibres is significantly higher in relation to all threats than that of vests of PBO (HM) fibres.

1. Ballistic vest comprising a stack of flexible unidirectional layers in which the unidirectional layers contain poly(p-phenylene-2,6,-benzobisoxazole) (PBO) fibres and in which the fibres in a unidirectional layer run substantially parallel and are positioned at an angle of more that n zero degrees relative to fibres in an adjacent layer, characterized in that the PBO fibres are as-spun PBO fibres.

2. Ballistic vest according to claim 1, wherein the PBO fibres have a modulus of less than 1300 cN/dTex.
